(19) United States
(12) Patent Application Publication
(10) Pub. No.: US 2023/0053015 A1
(43) Pub. Date: Feb. 16, 2023

(54) Magnetic air separator

(71) Applicant: Jan Vetrovec, Larkspur, CO (US)

(72) Inventor: Jan Vetrovec, Larkspur, CO (US)

(21) Appl. No.: 17/300,556

(22) Filed: Aug. 16, 2021

(51) Int. Cl. B03C 1/033; B03C 1/035

(52) U.S. Cl. CPC B03C 1/0332; B03C 1/035; B03C 2201/16

(57) ABSTRACT

This invention is for an innovative magnetic air separator (MAS) for delivering oxygen-enriched air or near-pure oxygen to for advanced combustion, coal gasification, industrial processes, and medical applications. In the MAS of the subject invention, input air is drawn into a large array of microchannels immersed in a strong, spatially varying magnetic field. Magnetic forces accelerate the paramagnetic O2 molecules within the microchannel flow and in a direction perpendicular to it, thus forming enriched and depleted streams. Such streams are then physically separated and subsequently combined according to their level of O2 enrichment or depletion. Highly enriched streams are repeatedly subjected to the magnetic separation process until the targeted level of O2 concentration is reached in selected streams. Partially enriched streams are recycled and fed back into the process feedstock air, while depleted streams are vented from the process.

### CROSS-REFERENCE TO RELATED APPLICATIONS

This application claims priority from the U.S. provisional patent application U.S. Ser. No. 63/103,639, filed on Aug. 14, 2020 and entitled “Magnetic Air Separator”, which is hereby incorporated by reference in its entirety.

### GOVERNMENT RIGHTS IN THIS INVENTION

This invention was reduced to hardware practice with U.S. Government support under the U.S. Department of Energy Grant No. DE-SC0019663. The U.S. Government may have certain rights in this invention.

### FIELD OF THE INVENTION

The present invention relates to air separation units and more particularly to devices producing oxygen enriched air or the like.

### BACKGROUND OF THE INVENTION

Oxygen (O2) enriched air is used for advanced combustion, coal gasification, industrial processes, and medical applications.

Coal Gasification Application: Coal is a plentiful natural resource in the U.S. but has been underused due to pollution resulting from conventional combustion. Gasification, as opposed to conventional combustion, is the most thermally efficient and cleanest way to convert the energy content of coal into electricity, hydrogen, clean fuels, and value-added chemicals. Gasification plants can run more efficiently and be configured to more economically capture Carmon dioxide (CO2) if the oxidant is oxygen rather than air. The combustion of fossil fuels in nearly pure O2, rather than air, can simplify CO2 capture in fossil fuel power plants. When pure or enriched O2 stream is used in a power plant, the volume of flue gas can be reduced by 75% compared with air-fired combustion. The lower off-gas volume can not only reduce the removal cost of pollutants but also reduce NOx production due to reduced nitrogen content. Gasification plant integrators seek an air separation unit (ASU) that would produce concentrated O2 at very low cost.

On-site oxygen production for coal gasification conventionally uses cryogenic air separation technology. The cryogenic ASU in a conventional gasification plant typically accounts for 12 to 15% of the overall capital cost of the plant, and requires a large parasitic power load primarily to operate gas compressors. Cryogenic ASU is cost effective only in large systems. Alternative air separation technologies include permeation-selective membranes and pressure swing-absorption (PSA). Such systems with limited capacity are now available commercially. While the membrane and PSA systems show cost advantages over cryogenic ASU in smaller installations, more effective and robust components must be development before deployment. Limitations and high cost of existing cryogenic, membrane, and PSA technologies provides an impetus for development of advanced air separation technology for generation of commercial-scale quantities of oxygen at significantly lower cost while being more compact and conducive to modular configuration for integration with smaller plants having 1 to 5 MW of total power capacity. The lack of suitable technology impedes a wide-spread adoption of O2-based combustion.

Medical Applications: The primary factors fueling global demand for portable O2 concentrators are an increasing prevalence of chronic obstructive pulmonary diseases, growing consumer awareness for oxygen therapy devices, a changing consumer lifestyle, adoption of new technologies, increased government expenditure, and a rise in investment by manufacturing companies towards the production of homecare products. O2 concentrators are used by patients requiring supplemental oxygen for pulmonary disorders such as bronchitis, emphysema, lung cancer, and acute pneumonia. O2 concentrators can be efficiently used at home as well as clinical settings to support the user's oxygen needs. Market growth is driven by the popularity and high demand for oxygen concentrators, due to their ease of use. Thus, many players in this market focus on incorporating significant changes in product design to suit patients' routines.

For the medical portable units, the liquid O2 and cryogenic approaches are inappropriate, thus, membrane and PSA systems are used. Due to moving/high-pressure components, such systems are very costly, typically $1,200 per unit, a required significant operating power, and make noise.

Prospects for Magnetic Air Separation: Oxygen is strongly paramagnetic while other constituents of air, namely nitrogen, carbon dioxide, and water vapor are diamagnetic, as seen in FIG. 1. Paramagnetic materials are drawn into stronger magnetic field whereas diamagnetic materials are expelled from it, as seen in FIG. 2. In particular, the magnetic force Fₘ acting on a unit volume of paramagnetic gas of density ρ and magnetic susceptibility χ immersed in a magnetic field with flux density B can be expressed as Fₘ=1/(2μₒ)·ρχ∇B² where μₒ is magnetic permeability of vacuum and ∇B²=2B.∇B. The resulting acceleration acting on an oxygen gas molecule in the direction of magnetic field gradient ∇B can be orders of magnitudes higher than the gravitational acceleration. This suggests that the magnetic separation effect can be very strong.

Increased oxygen concentration near poles of strong magnets was observed over a century ago. This suggested that magnetic forces could be utilized for oxygen separation from air. In 1946, magnetic separation technique was employed in an oxygen analyzer (see, e.g., L. Pauling, R. E. Wood, and J. H. Sturdivant, “An Instrument for Determining of Partial Pressure of Oxygen in a Gas”, J. Am. Chem. Soc, Vol. 68, p. 795, 1946). Prospects for magnetic oxygen separation with concentrations and flow rates suitable for medical and industrial uses has been investigated by many but no practical devices were introduced. This is in-part due to technical challenges including diffusion, viscous shear, local turbulence, and remixing of separated species.

Asako showed that magnetic separation of oxygen is possible, but the achievable concentration he predicted using computational models was low (few percent) due to remixing by diffusion and flow dynamic effects. (see, e.g., Y. Asako, in: Proceedings of the ASME Heat Transfer Division-2004, vol. 375, 2004, p. 281). Recent experiments using permanent magnets demonstrated 0.65% oxygen enrichment of air in a single large channel (see, e.g., J. Cai, at al., “Study on oxygen enrichment from air by application of the gradient magnetic field,” J. of magnetism and magnetic materials, 230, 2008, pp 171-181).

The technical challenges including diffusion, viscous shear, local turbulence, and remixing of separated species separation process are overcome by staged magnetic separation of a flow in microchannels in accordance with the subject invention.

### SUMMARY OF THE INVENTION

This invention is for an innovative magnetic air separator (MAS) for delivering oxygen-enriched air or near-pure oxygen to applications such as gasification plants, fossil fuel power plans, industrial processes, and medical; uses.

In the MAS of the subject invention, input air is drawn into a large array of microchannels immersed in magnetic field with strong ∇B² (=2.B. ∇B) value. Magnetic forces transport O2 molecules with the microchannel flow generally in the direction transverse to the flow, thus forming enriched and depleted streams in each microchannel. Such streams are then physically separated and subsequently combined with like streams from other microchannels according to their level of O2 enrichment or depletion. Highly enriched streams are repeatedly subjected to the magnetic separation process until the targeted level of O2 concentration is reached in selected streams. Partially enriched streams are recycled and fed back into the process feedstock air, while depleted streams are vented from the process.

MAS attains high O2 concentration by repeating the separation process (aka staging). In particular, enriched streams from upstream microchannels are combined and injected into downstream microchannels for further separation. Similarly, lean streams from upstream microchannels may be combined and injected into downstream microchannels for further separation and O2 recovery. Highly depleted streams may be vented from the process. Slightly depleted streams may be fed back and combined with the feedstock.

The technical challenges encountered in prior art including diffusion, viscous shear, local turbulence, and remixing of separated species separation process are overcome by staged magnetic separation of a flow in microchannels.

In one embodiment of the subject invention, air flows inside the microchannels, while the paramagnetic O2 molecules drift toward the side of the microchannel with stronger magnetic field. Other air constituents (e.g., nitrogen, carbon dioxide, and water vapor) are only slightly diamagnetic and, therefore, are not significantly affected by the magnetic field. However, the resulting increase in partial pressure of oxygen along one microchannel wall causes the weakly diamagnetic air constituents to be driven to the other side of the microchannel. Oxygen enrichment limitations of a single stage separator are overcome by staged separation whereby oxygene enrichment is improved step-wise in downstream stages.

Accordingly, it is an object of the present invention to provide an MCR that is relatively simple and scalable in size. The key advantage of the innovative MAS is significantly lower capital and operating costs compared to existing air separation technology. Another advantage is the scalability of the technology from large systems for gasification plans to small portable devices for use in medical oxygen therapy. In particular, the innovative MAS has no moving parts except for the input air blower. The blower is also the only power consuming element of the innovative MAS. The required steady state magnetic field is conveniently produced by permanent magnets and requires no energy input. The simple construction of the innovative MAS requires very little maintenance.

Injection of highly concentrated O2 inexpensively produced by the innovative MAS enables much more economical gasification and it offers to stimulate wide adoption of the process. The resulting increased use of coal would lower energy costs and lessen country's dependence on foreign oil. Other commercial applications include a point-of-use oxygen generators for laboratories, manufacturing processes, and health care.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

FIG. 1 is a table of volume magnetic susceptibilities at standard conditions of several gases found in air.

FIG. 2 shows the effects of magnetic force on paramagnetic and diamagnetic molecules.

FIG. 3 is the magnetic air separation system in accordance with the subject invention.

FIG. 4 is the magnetic separator array

FIG. 5 is a view of an exemplary magnet structure with permanent magnets

FIG. 6 is a plot of ∇B² as a function of position in the horizontal mid-plane of the magnet gap of the magnet structure shown in FIG. 5.

FIG. 7 is a view of the magnetic air separation and enrichment in a microchannel.

FIG. 8 is a view of the staged microchannel-based magnetic air separator.

FIG. 9 is a schematic diagram showing the innovative architecture for combining partially enriched air stream after each separation stage and feeding them into the next stage of the separation process.

FIG. 10 is an isometric view of an exemplary microchannel array

FIG. 11 is a cross-sectional view 11-11 in the horizontal midplane of the microchannel array 370 of FIG. 10.

FIG. 12 is a cross-sectional view 12-12 in the vertical midplane of the microchannel array 370 of FIG. 10.

FIG. 13 is a cross-sectional view 13-13 in the horizontal plane of the microchannel array 370 of FIG. 12.

FIG. 14 is a cross-sectional view 14-14 in a horizontal plane of the microchannel array 370 of FIG. 12.

FIG. 15 is a cross-sectional view 15-15 in a horizontal plane of the microchannel array 370 of FIG. 12.

FIG. 16 is a cross-sectional view 16-16 in a horizontal plane of the microchannel array 370 of FIG. 12.

FIG. 17 is a cross-sectional view 17-17 in the middle plane of the microchannel array 370 of FIG. 12.

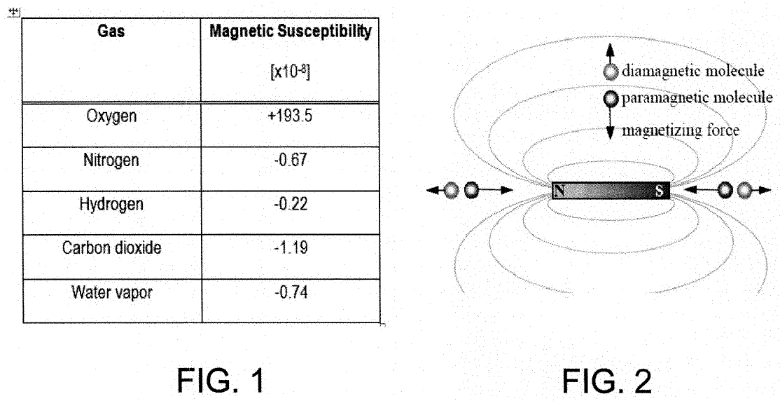

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

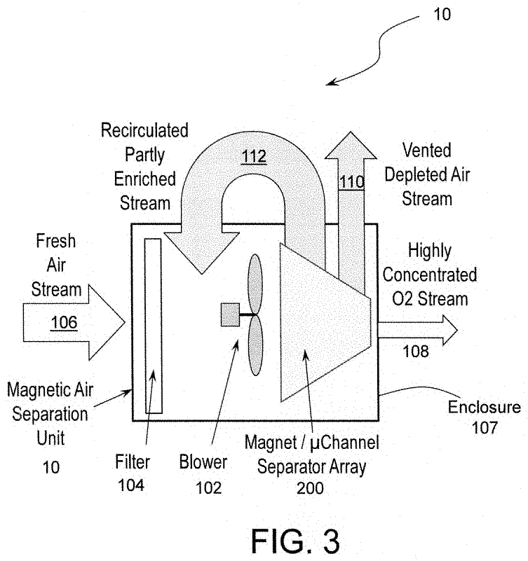

Referring now to FIG. 3, there is shown the magnetic air separation (MAS) system 10 of the subject invention comprising a magnetic separator assembly 200, blower 102, filter 104, an enclosure 107, a means for flowing in a stream of ambient air 106, a means for exhausting an oxygen-enriched air stream 108, a means for venting an oxygen-depleted air stream 110, and a means for recirculating an air stream with partly enriched oxygen content 112.

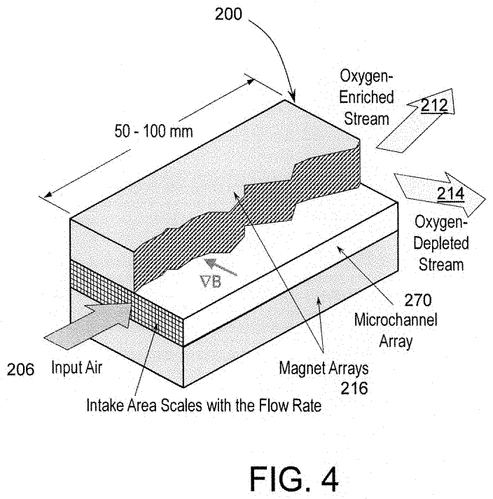

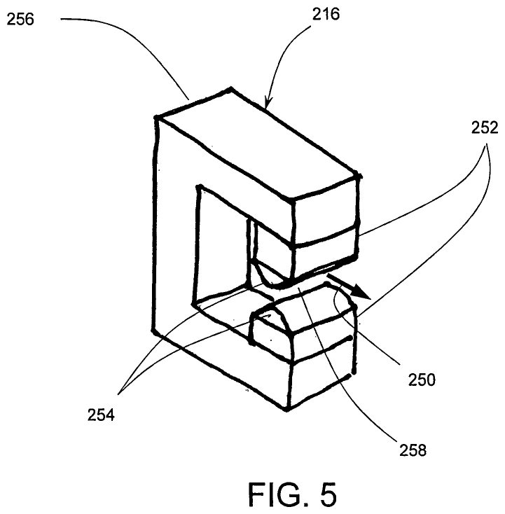

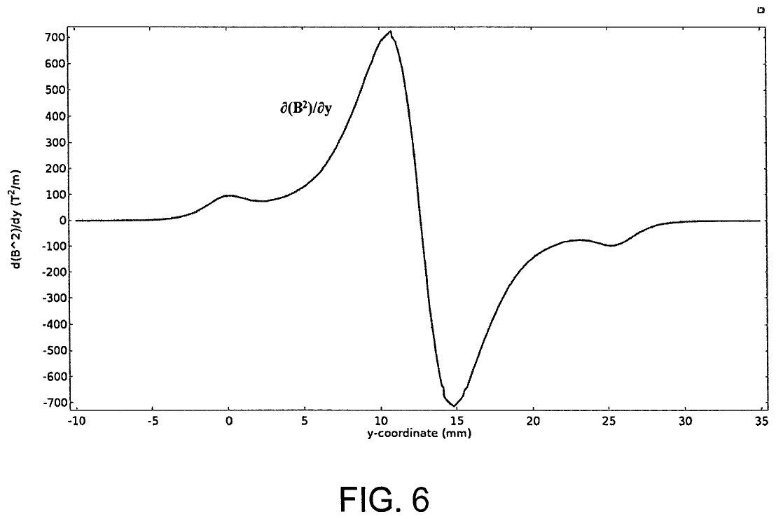

Referring now to FIG. 4, the magnetic separator assembly 200 comprises a magnet structure 216, and a microchannel array 270. The magnet structure 216 is arranged to produce a region of magnetic field with a strong magnetic field B and strong magnetic field gradient ∇B, a combination of which translates to a strong ∇B². The magnetic structure may comprise an electromagnet and/or a permanent magnet. FIG. 5 shows an exemplary magnet structure 216 comprising permanent magnets 252, pole pieces 254, flux return 256, and a magnet gap 258. Pole pieces 254 are preferably arranged to concentrate the magnetic flux. The corresponding ∇B² measured in the horizontal midplane of the magnet gap 258 in the direction of the arrow 250 may have a profile shown in FIG. 6. Peak ∇B² in FIG. 6 values attainable by this magnet structure may reach >1000 Tesla² per meter (T.

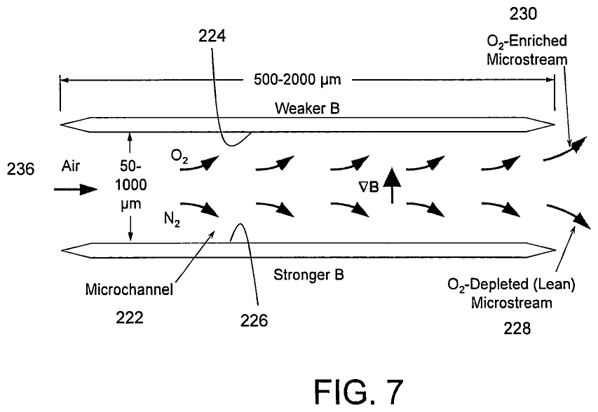

The microchannel array 270 comprises a plurality of microchannels 222 immersed in the magnetic field with high ∇B² produced by the magnet structure 216. Referring now to FIG. 7, a microchannel 222 comprises lateral side walls 224 and 226 approximately 500 to 2000 micrometers long, arranged to be substantially parallel, and separated by about 50 to 1000 micrometers. Arranging the microchannels to allow for staged separation is essential to the invention.

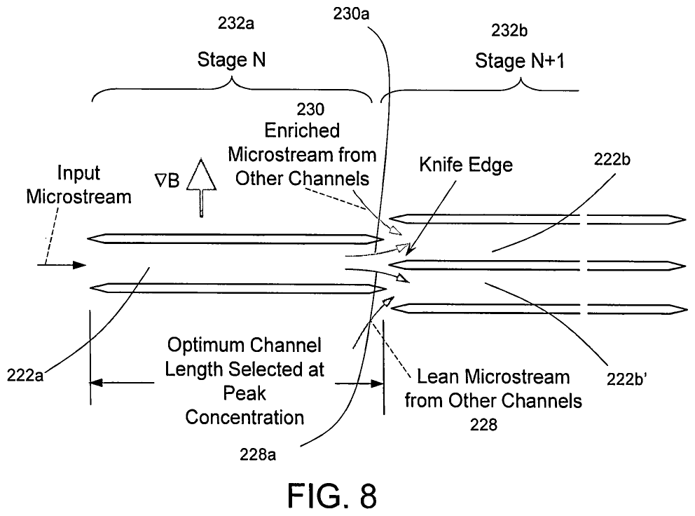

Referring now to FIG. 8, there is shown the relative position of an upstream microchannel 222a and downstream microchannels 222b and 222b′. The microchannel 222a is positioned so that its output can feed each the microchannels 222b and 222b′.

In operation, the blower 102 in FIG. 3 draws an air stream 106 through the filter 104 into the enclosure 107 and feeds it through the air separator 200, thus forming 3 streams: a highly oxygen enriched stream 108, an oxygen-depleted air stream 110, and an air stream with partly enriched oxygen 112. The highly oxygen enriched stream 108 is delivered from the air separator 200 to the point of application, which may be a combustion process, industrial process, medical application, or alike, or for storage in pressure tanks for later use.

Within the air separator 200, an air stream 236 (FIG. 7) is directed into the microchannel 222 where the aforementioned magnetic forces accelerate oxygen (O2) molecules in the direction of increasing ∇B, thereby increasing the partial pressure of O2 near the wall 224. Concurrently, the other air constituents (most notably nitrogen (N2)) are being forced toward the wall 226. As a result, an oxygen-enriched stream 230 and oxygen-depleted stream 228 are flowing from the end of the microchannel 222. The oxygen-enriched stream 230 together with oxygen-enriched streams from other microchannels (not shown) are injected into the microchannel 220b (FIG. 6) for further separation. The oxygen-depleted stream 228 together with oxygen-depleted streams from other microchannels (not shown) is injected into the microchannel 220b′ for further separation. The process may be repeated numerous times until the oxygen-enriched stream attains and acceptable degree of oxygen concentration.

In the process, a multitude of air streams may be formed that may be generally classified as “highly enriched” (with oxygen concentration significantly above the input air stream 106), “partially enriched” (with oxygen concentration slightly above the input air stream 106), “partially depleted” (with oxygen concentration slightly below the input air stream 106), and “highly depleted” (with oxygen concentration significantly below the input air stream 106). The highly enriched air stream 108 (FIG. 3) may be delivered to applications. The partially enriched and partially depleted streams may be recirculated as a stream 112 (FIG. 3) for further separation. The highly depleted stream 110 (FIG. 3) may be vented.

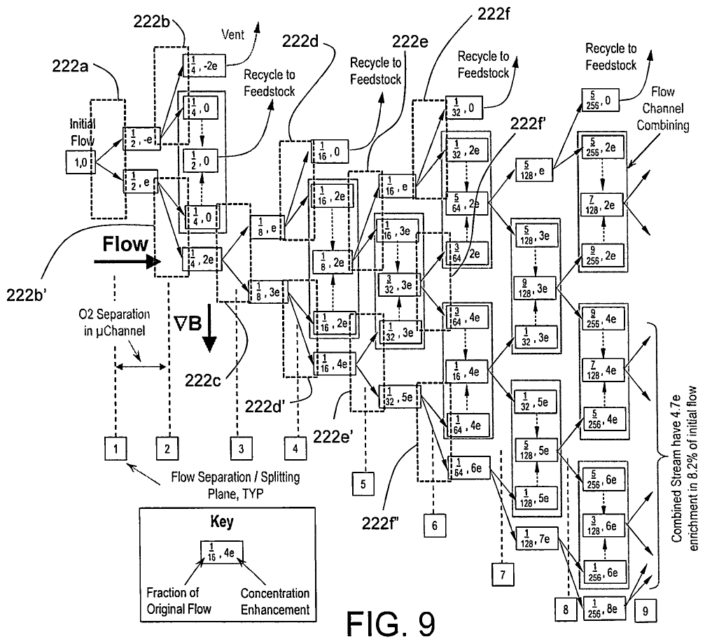

FIG. 9 schematically shows the shows the innovative architecture for the staging process, which involves selectively combining partially enriched air streams after each separation stage and feeding them into the next stage of the separation process. A stream with an initial flow rate “1” and oxygen concentration of “1” is deemed to form an oxygen-enriched stream with a flow rate “½” and an oxygen concentration “1+e” plus an oxygen-depleted stream with a flow rate “½” and an oxygen concentration “1−e”, where e is an enrichment factor <<1.

The exemplary map of the staging process and flow separation starting with a single microstream in FIG. 9 shows that the flow is split after each passage through a microchannel into an enriched and depleted streams, which are then combined with the like streams. As the air flows downstream through the separator flow element, the oxygen-enriched microstreams are becoming more enriched and the oxygen-depleted microstreams are becoming more depleted. At the exit port of the separator, the oxygen-enriched and oxygen-depleted microstreams are respectively combined into oxygen-enriched and oxygen-depleted streams. To obtain separator output with very high oxygen concentration, only the microstreams with highest oxygen content can be selected.

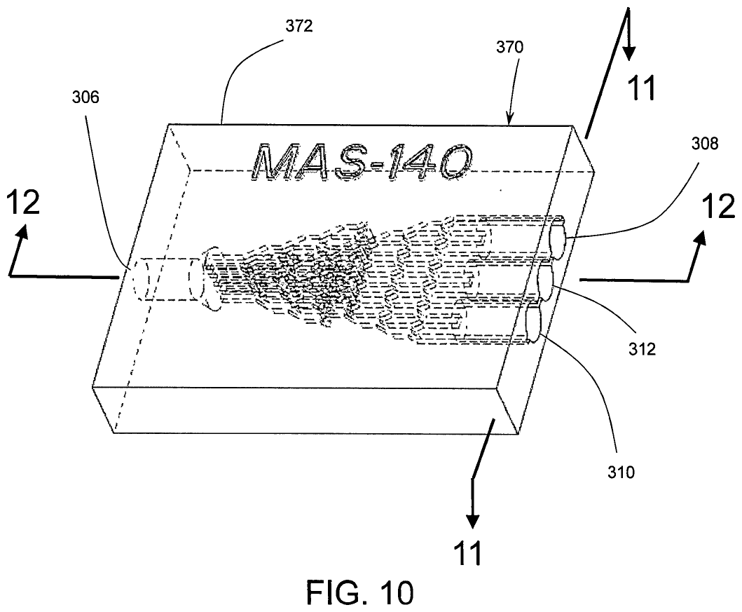

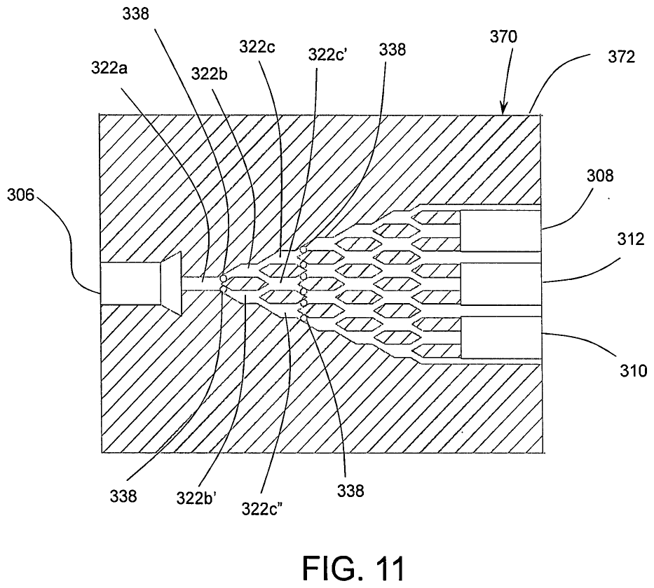

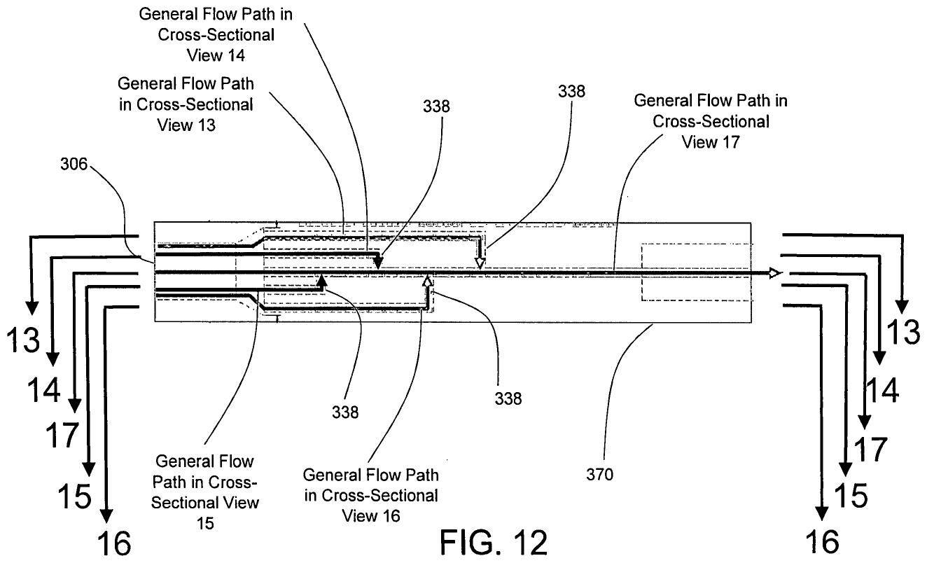

FIG. 10 shows an exemplary microchannel array 370 comprising a body 372, an inlet port 306, enriched stream output port 308, a depleted stream output port 310, and a vent port 312. FIG. 11 is a cross-sectional view 11-11 in the horizontal midplane of the microchannel array 370 of FIG. 10 showing a plurality of microchannels 322a⁽ⁱ⁾ to 322e^{(vi)}, and the flow passages 338 for interconnecting several layers of microchannels. FIG. 12 is a cross-sectional view 12-12 in the vertical midplane of the microchannel array 370 of FIG. 10 showing a plurality of microchannel layers, each layer being fluidly connected to the input port 306.

FIG. 13 is a cross-sectional view 13-13 in a horizontal plane of the microchannel array 370 of FIG. 12 showing a layer of microchannels, which connect to the microchannels in cross-sectional view 12-12 via flow passages 338.

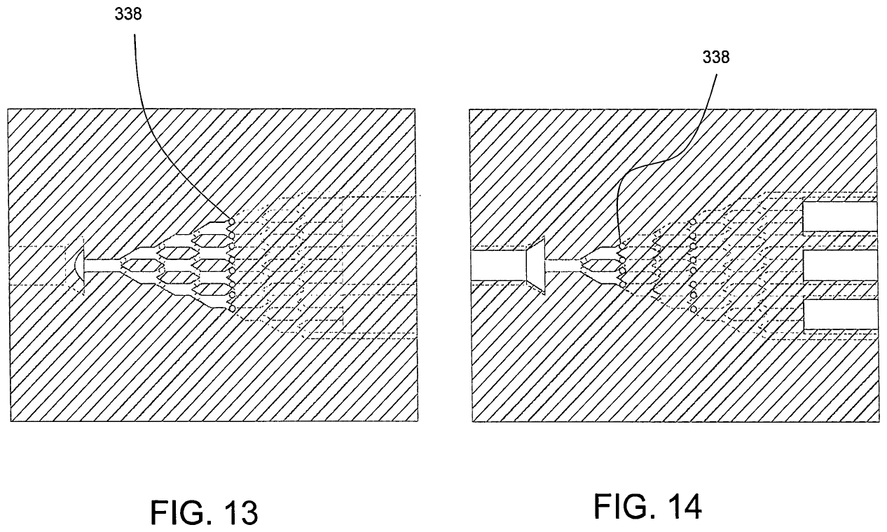

FIG. 14 is a cross-sectional view 14-14 in a horizontal plane of the microchannel array 370 of FIG. 12 showing a layer of microchannels, which connect to the microchannels in cross-sectional view 12-12 via flow passages 338.

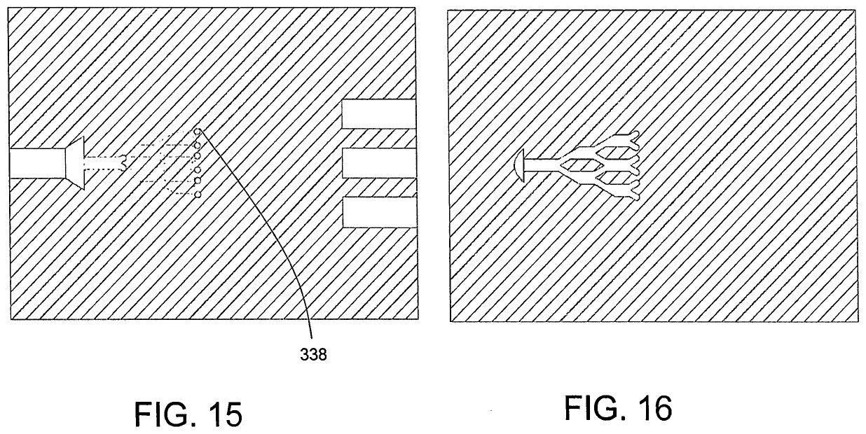

FIG. 15 is a cross-sectional view 15-15 in a horizontal plane of the microchannel array 370 of FIG. 12 showing a layer of microchannels, which connect to the microchannels in cross-sectional view 12-12 via flow passages 338.

FIG. 16 is a cross-sectional view 16-16 in a horizontal plane of the microchannel array 370 of FIG. 12 showing a layer of microchannels, which connect to the microchannels in cross-sectional view 12-12 via flow passages 338.

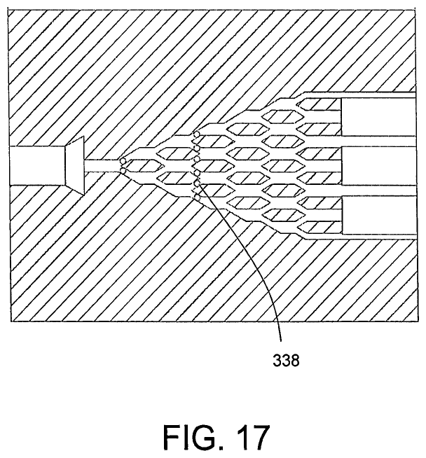

FIG. 17 is a cross-sectional view 17-17 in the middle plane of the microchannel array 370 of FIG. 12.

The input air stream 106 may be at ambient temperature and pressure, or at a sub-ambient pressure (including a near vacuum), or at a sub-ambient temperature (including a near cryogenic), or a combination of sub-ambient pressure and sub-ambient temperature. The sub-ambient conditions are deemed to reduce deleterious remixing and improve separation performance. This may be in-part due to the increased mean-free-path of the air molecules.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

The term “suitable”, as used herein, means having characteristics that are sufficient to produce a desired result. Suitability for the intended purpose can be determined by one of ordinary skill in the art using only routine experimentation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof. Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A magnetic air separator system comprising a magnetic structure and a microchannel array with an inlet port and a plurality of microchannels; wherein:
a. said magnetic array produces a region of high ∇B²;
b. said microchannels being immersed in said region of high ∇B²;
c. said microchannels being adapted for receiving air flow from said inlet;
d. said microchannel being adapted for forming a stream of oxygen enriched air and a stream of oxygen-depleted air;
e. said microchannel array being adapted for combining said streams of oxygen enriched air; and
f. said microchannel array being adapted for feeding said combined streams of oxygen enriched air into selected said microchannels;

2. The magnetic air separator system of claim 1, further comprising a means for feeding ambient air into said microchannel array.

3. The magnetic air separator system of claim 1, further comprising a permanent magnet.

4. The magnetic air separator system of claim 1, further comprising a pole piece adapted for concentration of magnetic flux.

5. The magnetic air separator system of claim 1, wherein said microchannels are approximately 500 to 2000 micrometers long.

6. The magnetic air separator system of claim 1, wherein said microchannels are arranged to be substantially parallel.

7. The magnetic air separator system of claim 1, wherein said microchannels are arranged for staged separation.

8. The magnetic air separator system of claim 1, further comprising a means for combining enriched streams from multiple microchannels.

9. The magnetic air separator system of claim 1, further comprising a means for combining enriched streams from multiple microchannels.

10. The magnetic air separator system of claim 9, further comprising a means for feeding said enriched streams to the next separation stage.

11. The magnetic air separator system of claim 1, further comprising a means for combining partly depleted streams from multiple microchannels.

12. The magnetic air separator system of claim 11, further comprising a means for feeding said partly depleted streams to the next separation stage.
